(19) United States
(12) Patent Application Publication
(10) Pub. No.: US 2008/0319621 A1
(43) Pub. Date: Dec. 25, 2008

(54) Running Mechanism for a Passenger Boarding Bridge and Control Method Thereof

(76) Inventor: Wei Xiang, Guangdong (CN)

Correspondence Address: BYIP, LTD., P.O. BOX 1484, GENERAL POST OFFICE, HONG KONG, CN

(21) Appl. No.: 12/091,487

(22) PCT Filed: Aug. 8, 2006
(86) PCT No.: PCT/CN2006/002007

§ 371 Date: Apr. 25, 2008

(30) Foreign Application Priority Data
Oct. 27, 2005 (CN) 200510100860.3

(51) Int. Cl. B64F 1/305; G06F 17/00

(52) U.S. Cl. 701/69; 14/72.5

(57) ABSTRACT

A running mechanism of a passenger boarding bridge and a control method thereof are provided. The running mechanism includes a beam, two rotary supporting members, and two running wheel sets. Each of the rotary supporting members is pivotally connected to one end of the beam, and connected to the respective running wheel set also. The running mechanism includes four driving devices for driving four running wheels, respectively. The control method is used to provide a matching control for the four running wheels, such that no sliding friction is generated between the running wheels and a ground surface when the passenger boarding bridge is turning.

### FIELD OF THE INVENTION

The present invention relates to structure of a passenger boarding bridge and the control method thereof. Specifically, the present invention relates to a running mechanism of a passenger boarding bridge and the control method thereof.

### BACKGROUND

Majority passenger boarding bridges in airports currently use a two-wheel running mechanism with single-point support. Such boarding bridges can serve doors of ordinary aircrafts. If the boarding bridges are used to serve upper doors of double-decked aircrafts, sloshing is relatively big during traveling due to the upper doors are too high, which makes them difficult to meet the requirements of relevant standards. In order to solve this problem, a passenger boarding bridge with a four-wheel running mechanism was provided, as shown in FIG. 1. The bridge has two running wheel sets disposed on two sides of a beam of the running mechanism, and each set has two running wheels. The rotating and running of each running wheel set is respectively driven by two motors. The running mechanism has the following problems.
1. The structure of the mechanism is complex, and the failure of the mechanism could easily happen.
2. The control method is complex, and the failure of the control system could happen.
3. During the process of running and rotation, due to unmatched speeds of the running wheels, sliding friction exists between the running wheels and the ground surface, and the surfaces of running wheels could be worn severely.

### SUMMARY

An object of the present invention is to solve the problems, such as complex structure existing in the aforementioned two-wheel running mechanism of the boarding bridge, and to provide a running mechanism of a passenger boarding bridge.

A further object of the present invention is to solve the problems existing in the two-wheel running mechanism of the boarding bridge in the prior art, such as complex method of controlling and severe attrition on the surfaces of running wheels because of the sliding friction between the running wheels and the ground surface. The object is to provide a running mechanism of a passenger boarding bridge and a control method to reduce the attrition on the surfaces of running wheels.

To solve the above-mentioned problems, an embodiment of the present invention provides a running mechanism of a passenger boarding bridge, which includes a beam, two rotary supporting members respectively rotarily connected to underneath portions of two ends of the beam, and two running wheel sets respectively pivotally connected to lower ends of the two rotary supporting members at two pivotal points. Each of the running wheel sets includes a wheel carrier and two running wheels respectively connected to two ends of the wheel carrier. The pivotal point is on the wheel carrier. The running mechanism further includes four driving devices respectively driving four running wheels of the two running wheel sets at lateral sides of the running wheels.

In the running mechanism of passenger boarding bridge, each of the driving devices includes a speed reduction device and a motor connected with the speed reduction device.

In the running mechanism of passenger boarding bridge, the speed reduction device is at the lateral side of the running wheel, and the wheel carrier has a hollow structure. The motor is mounted inside the hollow structure of the wheel carrier.

In the running mechanism of passenger boarding bridge, the motor is an electric motor or a hydraulic motor.

The running mechanism of passenger boarding bridge further includes an angle transducer on the rotary supporting member adjacent to the beam, and the angle transducer is adapted to communicate with a control device of the passenger boarding bridge.

To solve the above-mentioned problems, a method for controlling a running mechanism of a passenger boarding bridge is provided. The running mechanism includes a beam, two rotary supporting members respectively rotarily connected to underneath portions of two ends of the beam, and two running wheel sets respectively pivotally connected to lower ends of the two rotary supporting members at two pivotal points. Each of the running wheel sets includes a wheel carrier and two running wheels respectively connected to two ends of the wheel carrier. The pivotal point is on the wheel carrier. The running mechanism further includes four driving devices respectively driving four running wheels of the two running wheel sets at lateral sides of the running wheels, an angle transducer on the rotary supporting member adjacent to the beam, and a control system of the passenger boarding bridge. The control system includes a programmable logic controller, and the angle transducer is adapted to communicate with the programmable logic controller. The method for controlling a running mechanism of a passenger boarding bridge includes the following steps:
a. submitting a command an operator to the programmable logic controller to control the gradual turning of the running mechanism and to control the speed of a first running wheel;
b. calculating an instantaneous speed of other three running wheels by the programmable logic controller according to a wheel carrier angle of the two running wheel sets acquired by the angle transducer and the speed of the first running wheel, the instantaneous speeds of the other three running wheels matching with the speed of the first running wheel, which reduces relative sliding between the four running wheels and a ground surface; and
c. sending commands by the programmable logic controller to control the driving devices of the other three running wheels and to keep the instantaneous speed of the three running wheels.

The first running wheel is any one of the four running wheels, and the instantaneous speeds of the three other running wheels dynamically match with the speed of the running wheel through controlling the programmable logic controller.

The commands are submitted to the programmable logic controller through operation of a handle by an operator.

The beneficial effects of the running mechanism of the passenger boarding bridge and the control method thereof are as follows.
1. The structure is simple, so that the probability of failure of the running mechanism is reduced.
2. Unlike the prior art, the control method significantly reduces the sliding between the running wheels and the ground surface through controlling the matching speeds of the four running wheels. The abrasion on the surfaces of the running wheels is reduced, and the life span of the running wheels is increased.
3. The control method is simple, so that the probability of failure of the running mechanism and maintenance cost of the boarding bridge are reduced.

### BRIEF DESCRIPTION OF THE DRAWINGS

The present invention will be further described with reference to the accompanying drawings and embodiments hereinafter, in the accompanying drawings:

FIG. 1 is a schematic view of a prior art running mechanism for a boarding bridge;

FIG. 2 is a schematic view of a boarding bridge;

FIG. 3 is a schematic view of a running mechanism and an elevator of the boarding bridge;

FIG. 4 is enlarged view of an embodiment of the running mechanism of the boarding bridge; and

FIG. 5 is a flowchart showing a method for controlling the running mechanism of the boarding bridge.

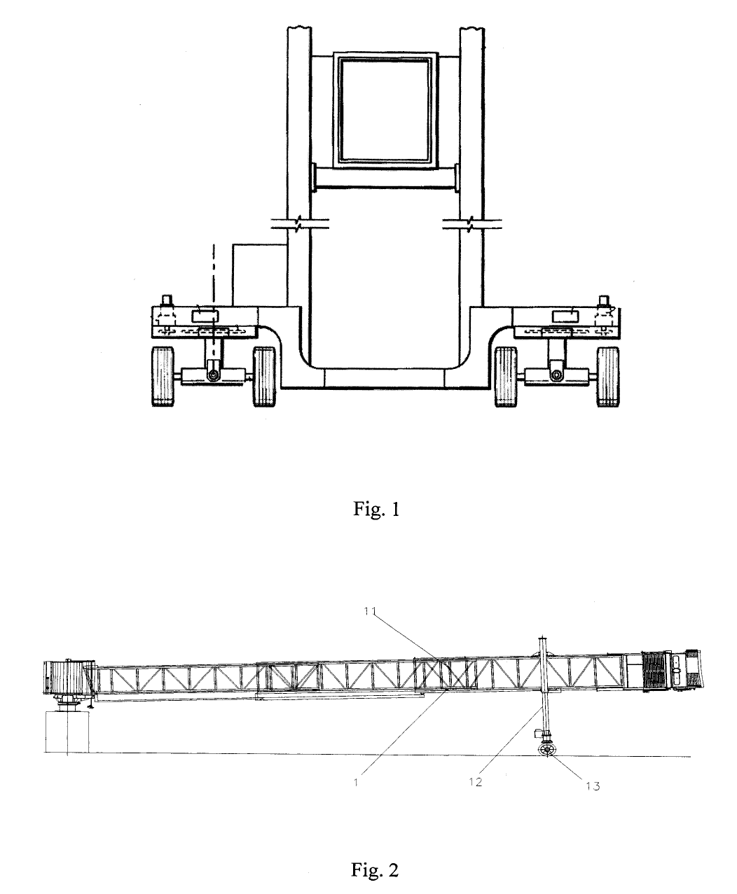

### DETAILED DESCRIPTION

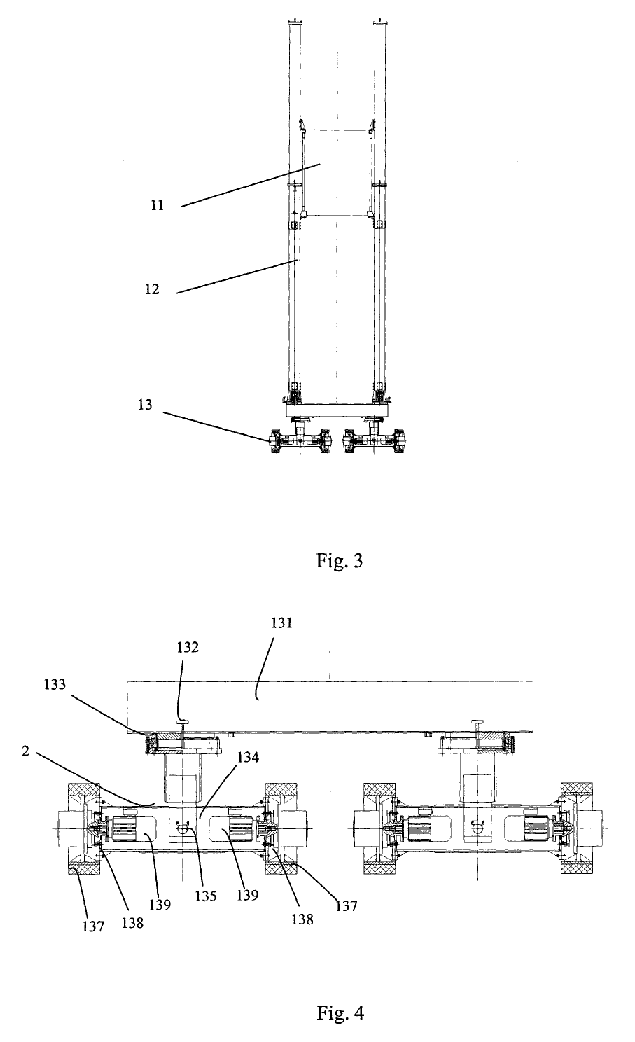

As shown in FIGS. 2 and 3, a tunnel 11 of a boarding bridge 1 is supported on a running mechanism 13 via an elevator 12.

FIG. 4 is the running mechanism of the boarding bridge according to an embodiment of the present invention. The running mechanism 13 includes a beam 131, rotary supporting members 133, and running wheel sets 2. The two rotary supporting member sets 133 are rotarily connected to the underneath portions of two ends of the beam 131, respectively. An angle transducer 132 is provided on the rotary supporting member 133 adjacent to the beam 131. The angle transducer 132 communicates with a control device of the boarding bridge to react to the rotating angles of the rotary supporting members 133 relative to the beam 131. The lower ends of the rotary supporting members 133 are pivotally connected to wheel carriers 134 of the running wheel sets 2 by pins 135.

Each running wheel set 2 has the wheel carrier 134, as well as two running wheels 137 respectively connected to the two ends of the wheel carrier 134. An electric motor 139 is installed for each running wheel 137, and the electric motor 139 drives the corresponding running wheel 137 through a speed reduction device 138 at the lateral side of the wheel. The wheel carrier 134 has a hollow structure. The electric motor 139 is mounted inside the hollow structure of the wheel carrier 134. It is to be understood that the electric motor 139 can be substituted by a hydraulic motor.

In another embodiment, the running wheel 137 is directly driven by a speed reduction electric motor or a speed reduction hydraulic motor with a speed reduction device at the lateral side of the wheel. The speed reduction electric motor or the speed reduction hydraulic motor is mounted inside or outside of the hollow structure of the wheel carrier 134. The speed reduction electric motor or the speed reduction hydraulic motor transfers rotational forces to the central axis of the running wheel 137 by a transmission device.

In yet another embodiment, the running wheel 137 is driven by a speed reduction device mounted inside the hollow structure of the wheel carrier 134 and by an electric motor or a hydraulic motor mounted outside the hollow structure of the wheel carrier 134. Alternatively, both the speed reduction device and the electric motor (or the hydraulic motor) are mounted outside the wheel carrier 134.

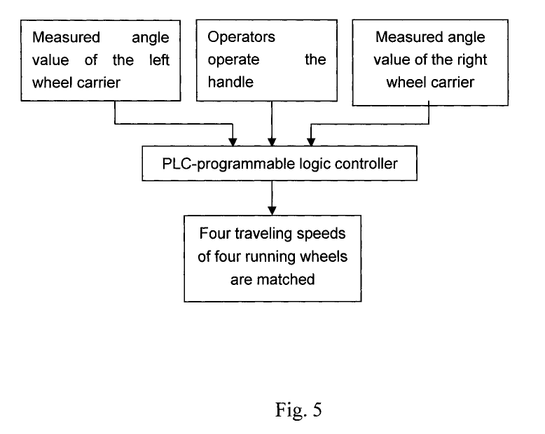

The running mechanism 13 enables the boarding bridge to run and turn. Referring to FIG. 5, the control method of the running mechanism 13 is described below.

An operator initially submits a command to a PLC (programmable logic controller) through operation of a handle to control the gradual turning of the running mechanism 13 of boarding bridge and the speed of one running wheel. The running wheel can be selected from the four running wheels.

According to a wheel carrier angle (an angle between the wheel carrier 134 and the tunnel of boarding bridge 11) of the two running wheel sets acquired by the angle transducer 132 and the speed of the one running wheel, the PCL calculates the instantaneous speeds of the other three running wheels. The instantaneous speeds of the other three running wheels match with the speed of the one running wheel. The relative sliding between the four running wheels and the ground surface is decreased, as compared to the prior art.

The PLC sends command to driving devices of the other three running wheels and controls the driving devices to ensure the speed of the one running wheel matching with the instantaneous speeds of the other three running wheels.

The PLC controls the dynamic matching between the speed of the one running wheel and the instantaneous speeds of the three other running wheels to accommodate speed changes. The relative sliding between the four running wheels and the ground surface is decreased, as compared to the prior art.

In addition to submitting commands to the PLC through operation of the handle, operators can use different operating devices according to the boarding bridge and submit commands to the PLC through the corresponding operating devices, such as submitting commands to the PLC through operation buttons.

1-8. (canceled)

9: A running mechanism of a passenger boarding bridge, comprising:
a beam;
two rotary supporting members respectively rotarily connected to underneath portions of the beam adjacent to two ends of the beam;
two running wheel sets respectively pivotally connected to the two rotary supporting members at lower ends thereof, each of the running wheel sets comprising a wheel carrier and two running wheels respectively connected to two ends of the wheel carrier; and
four driving devices adapted to drive four running wheels of the two running wheel sets at lateral sides of the running wheels respectively.

10: The running mechanism of claim 9, wherein the two running wheel sets are respectively pivotally connected to the two rotary supporting members at two pivotal points, the two pivotal points are respectively located on the two wheel carriers of the two running wheel sets.

11: The running mechanism of claim 9, wherein each of the driving devices comprises a speed reduction device and a motor connected with the speed reduction device.

12: The running mechanism of claim 11, wherein the speed reduction device is at the lateral side of the running wheel.

13: The running mechanism of claim 11, wherein the wheel carrier comprises a hollow structure, and the motor is mounted inside the hollow structure.

14: The running mechanism of claim 11, wherein the motor comprises an electric motor or a hydraulic motor.

15: The running mechanism of claim 9, further comprising
a control system; and
an angle transducer on the rotary supporting member adjacent to the beam, and the angle transducer adapted to communicate with of the control system.

16: The running mechanism of claim 9, wherein a speed of one of the running wheels matches with the instantaneous speeds of three other running wheels.

17: A running mechanism of a passenger boarding bridge, comprising:
a beam;
two rotary supporting members respectively rotarily connected to underneath portions of the beam adjacent to two ends of the beam;
two running wheel sets respectively pivotally connected to the two rotary supporting members at lower ends thereof, each of the running wheel sets comprising a wheel carrier and two running wheels respectively connected to two ends of the wheel carrier;
four driving devices adapted to drive four running wheels of the two running wheel sets at lateral sides of the running wheels respectively;
a control system comprising a programmable logic controller; and
an angle transducer on the rotary supporting member adjacent to the beam, the angle transducer adapted to communicate with the programmable logic controller.

18: The running mechanism of claim 17, wherein the two running wheel sets are respectively pivotally connected to the two rotary supporting members at two pivotal points, the two pivotal points are respectively located on the two wheel carriers of the two running wheel sets.

19: The running mechanism of claim 17, wherein each of the driving devices comprises a speed reduction device and a motor connected with the speed reduction device.

20: The running mechanism of claim 19, wherein the speed reduction device is at the lateral side of the running wheel.

21: The running mechanism of claim 19, wherein the wheel carrier comprises a hollow structure, and the motor is mounted inside the hollow structure.

22: The running mechanism of claim 19, wherein the motor comprises an electric motor or a hydraulic motor.

23: The running mechanism of claim 17, wherein a speed of one of the running wheels matches with the instantaneous speeds of three other running wheels.

24: A method for controlling a running mechanism of a passenger boarding bridge, wherein the running mechanism comprises:
a beam;
two rotary supporting members respectively rotarily connected to underneath portions of the beam adjacent to two ends of the beam;
two running wheel sets respectively pivotally connected to the two rotary supporting members at lower ends thereof, each of the running wheel sets comprising a wheel carrier and two running wheels respectively connected to two ends of the wheel carrier;
four driving devices adapted to drive four running wheels of the two running wheel sets at lateral sides of the running wheels respectively;
a control system comprising a programmable logic controller; and
an angle transducer on the rotary supporting member adjacent to the beam, the angle transducer adapted to communicate with the programmable logic controller;
the method comprising:
submitting a command by an operator to the programmable logic controller to control gradual turning of the running mechanism and to control a speed of a first running wheel;
calculating an instantaneous speed of three other running wheels by the programmable logic controller according to a wheel carrier angle of the two running wheel sets acquired by the angle transducer and the speed of the first running wheel, wherein the instantaneous speeds of the three other running wheels match with the speed of the first running wheel, which reduces relative sliding between the four running wheels and a ground surface; and
sending commands by the programmable logic controller to control the driving devices of the three other running wheels and to keep the instantaneous speeds of the three running wheels.

25: The method for controlling the running mechanism of claim 24, wherein the first running wheel is any one of the four running wheels, and the instantaneous speeds of the three other running wheels dynamically match with the speed of the first running wheel through controlling the programmable logic controller.

26: The method for controlling the running mechanism of claim 24, wherein the commands are submitted to the programmable logic controller through operation of a handle by an operator.
